(19) United States
(12) Patent Application Publication
(10) Pub. No.: US 2019/0150112 A1
(43) Pub. Date: May 16, 2019

(54) WIRELESS COMMUNICATION DEVICE AND TIME AND FREQUENCY SYNCHRONIZATION METHOD AND NON-TRANSITORY COMPUTER READABLE MEDIUM OF THE SAME

(71) Applicant: INSTITUTE FOR INFORMATION INDUSTRY, TAIPEI (TW)

(72) Inventors: Tsung-Yu TSAI, Tainan City (TW); Chin-Gwo MA, New Taipei City (TW)

(21) Appl. No.: 15/826,723

(22) Filed: Nov. 30, 2017

(30) Foreign Application Priority Data
Nov. 16, 2017 (TW) 106139764

(51) Int. Cl. H04W 56/00; H04L 27/26; H04B 17/354; H04J 11/00

(52) U.S. Cl. CPC H04W 56/002; H04L 27/2605; H04J 2011/0096; H04J 11/00; H04B 17/354

(57) ABSTRACT

A time and frequency synchronization method that includes the steps outlined below is provided. A wireless signal from a base station is received and orthogonal frequency-division multiplexing symbols of a primary synchronization signal of the wireless signal on a time domain is identified. The orthogonal frequency-division multiplexing symbols are transformed to a frequency domain to generate original symbol signals. An inner product of the original symbol signals and the received symbol signals is generated to obtain a product of a power leakage coefficient and a channel gain. A line search is performed to approximate an actual value of a fractional carrier frequency offset of the wireless signal based on the power leakage coefficient.

### CROSS-REFERENCE TO RELATED APPLICATION

This application claims priority to Taiwan Application Serial Number 106139764, filed on Nov. 16, 2017, which is herein incorporated by reference.

### BACKGROUND

### Field of Invention

The present invention relates to a wireless communication technology. More particularly, the present invention relates to a wireless communication device, a time and frequency synchronization method and non-transitory computer readable medium of the same.

### Description of Related Art

When a wireless communication device communicate with a base station, a step of synchronizing the time and frequency of the carrier is required. Some synchronizing approaches search the cyclic prefix of other data channels to estimate the fractional carrier frequency offset first and process the primary synchronization signal subsequently to retrieve the integer carrier frequency offset. In such approaches, a large amount of correlation calculations are required since the convergence is slow when the cyclic prefix is used. Further, the data channel is not necessarily presented. An additional algorithm is required to determine whether the secondary synchronization signal is presented or not. As a result, the reliability is not ideal by using such approaches.

Accordingly, what is needed is a wireless communication device, a time and frequency synchronization method and non-transitory computer readable medium of the same to address the above issues.

### SUMMARY

The invention provides a time and frequency synchronization method used in a wireless communication device. The time and frequency synchronization method includes the steps outlined below. A wireless signal is received from a base station and a plurality of orthogonal frequency-division multiplexing (OFDM) symbols of a primary synchronization signal (PSS) of the wireless signal on a time domain are identified. The OFDM symbols are transformed to a frequency domain to generate a plurality of original symbol signals. An inner product of the original symbol signals and a plurality of received symbol signals is generated to obtain a product of a power leakage coefficient and a channel gain. An actual value of a fractional carrier frequency offset of the wireless signal is approximated according to the power leakage coefficient by using a line search method.

Another aspect of the present invention is to provide a wireless communication device that includes a storage module and a processing module. The storage module is configured to store a plurality of computer executable instructions. The processing module is coupled to the storage module and configured to execute the computer executable instructions to perform a time and frequency synchronization method. The time and frequency synchronization method includes the steps outlined below. A wireless signal is received from a base station and identifying a plurality of OFDM symbols of a PSS of the wireless signal on a time domain. The OFDM symbols are transformed to a frequency domain to generate a plurality of original symbol signals. An inner product of the original symbol signals and a plurality of received symbol signals is generated to obtain a product of a power leakage coefficient and a channel gain. An actual value of a fractional carrier frequency offset of the wireless signal is approximated according to the power leakage coefficient by using a line search method.

Yet another aspect of the present invention is to provide a non-transitory computer readable medium that stores a computer program including a plurality of computer readable instructions to execute a time and frequency synchronization method used in a wireless communication device, the wireless communication device includes a storage module configured to store the computer executable instructions and a processing module configured to execute the computer executable instructions to execute the time and frequency synchronization method. The time and frequency synchronization method includes the steps outlined below. A wireless signal is received from a base station and identifying a plurality of OFDM symbols of a PSS of the wireless signal on a time domain. The OFDM symbols are transformed to a frequency domain to generate a plurality of original symbol signals. An inner product of the original symbol signals and a plurality of received symbol signals is generated to obtain a product of a power leakage coefficient and a channel gain. An actual value of a fractional carrier frequency offset of the wireless signal is approximated according to the power leakage coefficient by using a line search method.

These and other features, aspects, and advantages of the present invention will become better understood with reference to the following description and appended claims.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a block diagram of a wireless communication device in an embodiment of the present invention;

FIG. 2 is a flow chart of a time and frequency synchronization method in an embodiment of the present invention; and

FIG. 3 is a diagram of the relation between a square of the power leakage coefficient and the fractional carrier frequency offset that is under searching in an embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

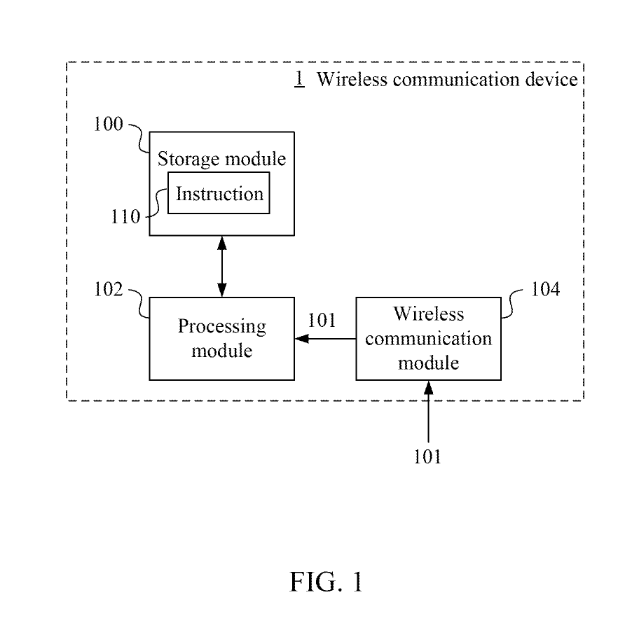

Reference is now made to FIG. 1. FIG. 1 is a block diagram of a wireless communication device 1 in an embodiment of the present invention. In an embodiment, the wireless communication device 1 is a handheld mobile communication device such as, but not limited to a smartphone or a tablet personal computer (PC). The wireless communication device 1 can perform wireless communication with a base station (not illustrated). When the wireless communication device 1 and the base station begin to connect, the procedure of time and frequency synchronization can be performed such that the communication can be correctly performed therebetween.

The wireless communication device 1 includes a storage module 100 and a processing module 102.

The processing module 102 is coupled to the storage module 100. The processing module 102 can be any processor that has the ability to perform data operation. The processing module 10 performs data transmission with the module described above by using different types of data transmission paths.

The storage module 100 is configured to store a plurality of computer executable instructions. In different embodiments, the storage module 100 can be such as, but not limited to a ROM (read-only memory), a flash memory, a floppy disc, a hard disc, an optical disc, a flash disc, a tape, an database accessible from a network, or any storage medium with the same functionality that can be contemplated by persons of ordinary skill in the art to which this invention pertains.

It is appreciated that the components mentioned above are exemplarily described. In other embodiments, the wireless communication device 1 may include other types of components.

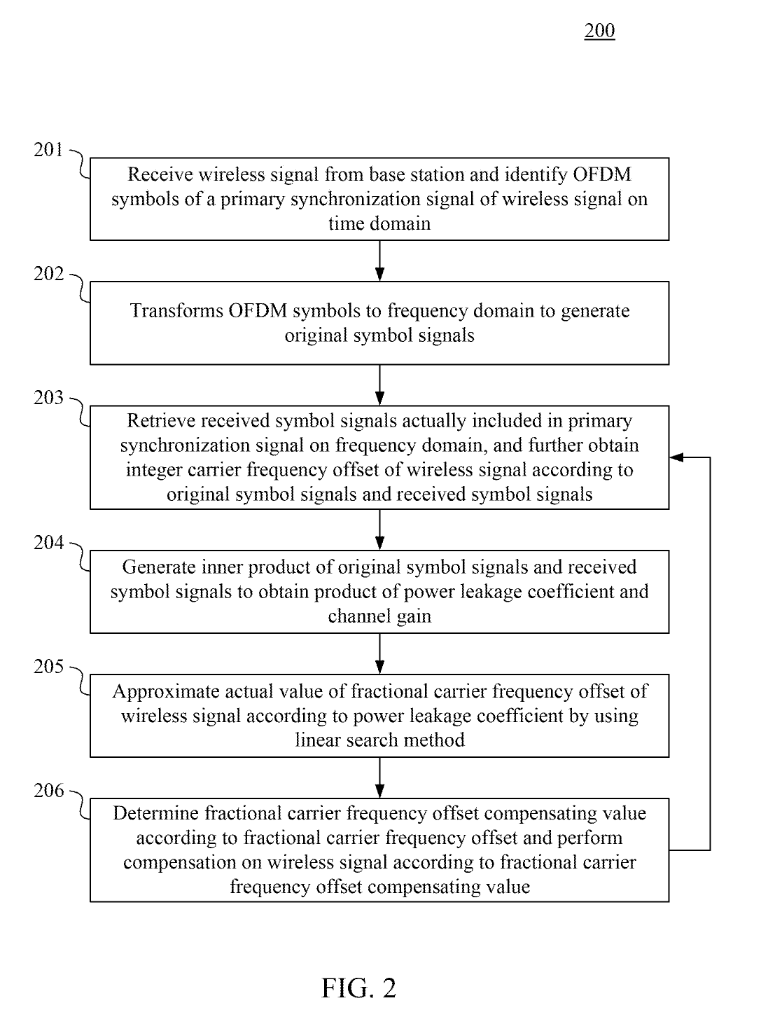

Reference is now made to FIG. 2. FIG. 2 is a flow chart of a time and frequency synchronization method 200 in an embodiment of the present invention. The time and frequency synchronization method 200 can be used in the wireless communication device 1 illustrated in FIG. 1, or be implemented by using other hardware components such as a database, a common processor, a computer, a server, other unique hardware devices that have a specific logic circuit or an equipment having a specific function, e.g. a unique hardware integrated by a computer program and a processor or a chip.

The time and frequency synchronization method 200 can be implemented by using a computer program to control the modules in the wireless communication device 1. The computer program can be stored in a non-transitory computer readable medium such as a ROM (read-only memory), a flash memory, a floppy disc, a hard disc, an optical disc, a flash disc, a tape, an database accessible from a network, or any storage medium with the same functionality that can be contemplated by persons of ordinary skill in the art to which this invention pertains.

More specifically, the computer readable medium can be such as the storage module 100 in FIG. 1 that is configured to store the computer executable instructions 110. The processing module 100 executes the instructions 110 to perform the time and frequency synchronization method 200 in FIG. 2 to provide the function of the wireless communication device 1.

The operation of the wireless communication device 1 and the time and frequency synchronization method 200 performed by the processing module 102 are described in the following paragraphs.

The time and frequency synchronization method 200 includes the steps outlined below. (The steps are not recited in the sequence in which the steps are performed. That is, unless the sequence of the steps is expressly indicated, the sequence of the steps is interchangeable, and all or part of the steps may be simultaneously, partially simultaneously, or sequentially performed).

In step 201, the processing module 102 receives the wireless signal 101 from the base station and identifies a plurality of orthogonal frequency-division multiplexing (OFDM) symbols of a primary synchronization signal (PSS) of the wireless signal 101 on a time domain.

In an embodiment, the processing module 102 receives the wireless signal 101 through a wireless communication module 104 further included in the wireless communication device 1. The wireless signal 101 includes the primary synchronization signal and a secondary synchronization signal. The primary synchronization signal is retrieved from finite sequence sets. One of the sequence sets therein is a cyclic shift of the other sequence sets.

Further, by performing sampling, the processing module 102 can retrieve the signal sequences of the wireless signal 101 along the time and perform calculation of such as, but not limited to a sliding correlation on these signal sequences to identify the OFDM symbols of the primary synchronization signal on the time domain.

In an embodiment, the primary synchronization signal may include such as, but not limited to three known patterns of the OFDM symbols. As a result, after the calculation of the sliding correlation, the processing module 102 can identify the OFDM symbols of the primary synchronization signal transmitted from the transmission terminal (e.g. base station).

In step 202, the processing module 102 transforms the OFDM symbols to a frequency domain to generate a plurality of original symbol signals D.

In an embodiment, the OFDM symbols occupy such as, but not limited to 127 resource elements on the frequency domain. As a result, the original symbol signals D generated by transforming the OFDM symbols to the frequency domain can be expressed as a vector of D=[d(0), d(1), d(126)]^{T}. Further, based on the original symbol signals D=[d(0), d(1), d(126)]^{T}, the processing module 102 can detect the sector ID of the base station.

In step 203, the processing module 102 retrieves a plurality of received symbol signals R actually included in the primary synchronization signal on the frequency domain, and further obtains an integer carrier frequency offset of the wireless signal 101 according to the original symbol signals D and the received symbol signals R.

In an embodiment, the received symbol signals R is the symbol signals actually received by the receive terminal and can be expressed by a vector of R=r=[r(0), r(1), , r(126)]^{T} as well. Since a condition of the frequency offset occurs at the channel between the base station and the wireless communication device 1, an integer carrier frequency offset and a fractional carrier frequency offset are generated. As a result, the integer carrier frequency offset can be obtained according to the difference between the original symbol signals D and the received symbol signals R by the processing module 102.

In step 204, the processing module 102 generates an inner product of the original symbol signals D and the received symbol signals R to obtain a product of a power leakage coefficient α(ε,0) and a channel gain G.

Since the sequences of the primary synchronization signal are M sequences that have a pseudo random characteristic, the neighboring sequences of the original symbol signals D are nearly orthogonal. The inter-carrier interference of the neighboring sub-carriers can be neglected. As a result, the inner product of the original symbol signals D and the received symbol signals R can neglect the interference of the neighboring sub-carriers and can be simplified as the product of the power leakage coefficient α(ε,0) and the channel gain G.

In step 205, the processing module 102 approximates an actual value of the fractional carrier frequency offset of the wireless signal 101 according to the power leakage coefficient by using a line search method.

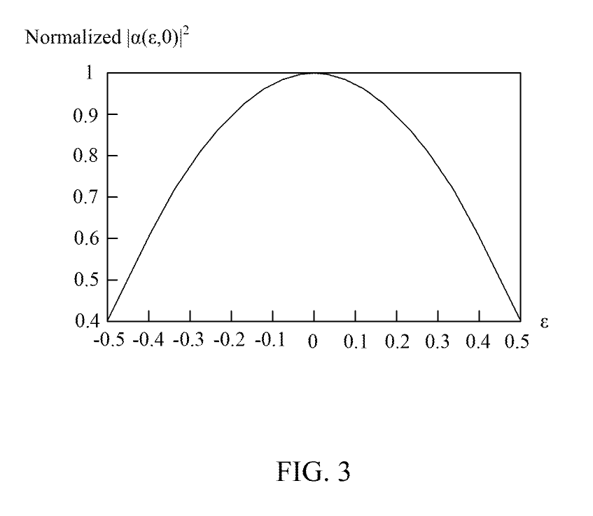

Reference is now made to FIG. 3. FIG. 3 is a diagram of the relation between a square of the power leakage coefficient |α(ε,0)|² and the fractional carrier frequency offset ε that is under searching in an embodiment of the present invention. The X-axis is the fractional carrier frequency offset ε and the Y-axis is the normalized square of the power leakage coefficient |α(ε,0)|².

In an embodiment, the square of the power leakage coefficient |α(ε,0)|² is a function of the fractional carrier frequency offset ε that is under searching, and the is |α(ε,0)|² a quasi-convex function.

As a result, the processing module 102 can search the fractional carrier frequency offset ε that makes the square of the power leakage coefficient |α(ε,0)|² have a local maximum by using the line search method. More specifically, the processing module 102 can keep iterating the value to perform comparison on two inner products of the original symbol signals D and the received symbol signals R obtained sequentially to determine the new value of the fractional carrier frequency offset ε. The actual value of the fractional carrier frequency offset ε of the wireless signal 101 can be approximated.

In different embodiments, the line search method includes a golden section search method, a Fibonacci search method, a dichotomous search method or a sequential search method.

In an embodiment, the processing module 102 can detect a cell ID from the secondary synchronization signal (SSS) of the wireless signal 101 according to the fractional carrier frequency offset ε.

In step 206, the processing module 102 can determine a fractional carrier frequency offset compensating value according to the fractional carrier frequency offset ε and perform compensation on the wireless signal 101 according to the fractional carrier frequency offset compensating value.

In an embodiment, after step 206 is finished, the flow goes back to step 203 to keep receiving the wireless signal 101. Further, after the compensation performed on the wireless signal 101 according to the fractional carrier frequency offset compensating value, the received symbol signals R actually included in the primary synchronization signal are retrieved and the value of the fractional carrier frequency offset ε is further approximated by using the steps 204 to 206.

In an embodiment, a subset of the original symbol signals D is selected to eliminate the inter-carrier interference (ICI) of the sub-carriers when the calculation of the inner product of the original symbol signals D and the received symbol signals R in the step 204 is performed. The accuracy of the retrieving of the power leakage coefficient α(ε,0) can be increased as well.

More specifically, the processing module 102 can select a subset of the original symbol signals D to generate the inner product together with the corresponding received symbol signals R to retrieve the power leakage coefficient α(ε,0) more accurately. The subset of the original symbol signals D, such as but not limited to d(K−1), . . . , d(K+L−2) are orthogonal after the values of K and L are well-selected.

In some time and frequency synchronization approaches, the secondary synchronization signal is processed first to obtain the fractional carrier frequency offset and the primary synchronization signal is processed subsequently to obtain the integer carrier frequency offset. A large amount of correlation calculations are required since the patterns of the secondary synchronization signal are diverse when such approaches are used. Further, the secondary synchronization signal is not necessarily presented in the wireless communication signal. An additional algorithm is required to determine whether the secondary synchronization signal is presented or not. As a result, the reliability is not ideal by using such approaches.

In comparison to such approaches, the advantage of the present invention is to retrieve the OFDM symbols of the primary synchronization signal to obtain the integer carrier frequency offset first. Subsequently, the known symbol signals on the frequency domain are further used to estimate the fractional carrier frequency offset. Not only the amount of calculation is decreased, the resistance against the noise is high. Further, since the primary synchronization signal is always presented, the reliability of the time and frequency synchronization method is high.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A time and frequency synchronization method used in a wireless communication device, the time and frequency synchronization method comprises:
receiving a wireless signal from a base station and identifying a plurality of orthogonal frequency-division multiplexing (OFDM) symbols of a primary synchronization signal (PSS) of the wireless signal on a time domain;
transforming the OFDM symbols to a frequency domain to generate a plurality of original symbol signals;
generating an inner product of the original symbol signals and a plurality of received symbol signals to obtain a product of a power leakage coefficient and a channel gain; and
approximating an actual value of a fractional carrier frequency offset of the wireless signal according to the power leakage coefficient by using a line search method.

2. The time and frequency synchronization method of claim 1, wherein the power leakage coefficient is a function of the fractional carrier frequency offset, and the time and frequency synchronization method further comprises:
searching for the fractional carrier frequency offset that makes a square of the power leakage coefficient reach a maximum by using the line search method.

3. The time and frequency synchronization method of claim 1, further comprising:
selecting a first subset of the original symbol signals, wherein the original symbol signals of the first subset and the original symbol signals in a second subset neighboring to the first subset are orthogonal to each other; and
generating the inner product of the original symbol signals of the first subset and the corresponding received symbol signals to obtain the product of the power leakage coefficient and the channel gain.

4. The time and frequency synchronization method of claim 1, wherein the line search method comprises a golden section search method, a Fibonacci search method, a dichotomous search method or a sequential search method.

5. The time and frequency synchronization method of claim 1, further comprising:
detecting a sector ID according to an integer carrier frequency offset of the wireless signal.

6. The time and frequency synchronization method of claim 1, further comprising:
detecting a cell ID from a secondary synchronization signal (SSS) of the wireless signal according to the fractional carrier frequency offset.

7. The time and frequency synchronization method of claim 1, further comprising:
determining a fractional carrier frequency offset compensating value according to the fractional carrier frequency offset; and
performing compensation on the wireless signal according to the fractional carrier frequency offset compensating value.

8. A wireless communication device comprising:
a storage module configured to store a plurality of computer executable instructions; and
a processing module coupled to the storage module and configured to execute the computer executable instructions to perform a time and frequency synchronization method, wherein the time and frequency synchronization method comprises:
receiving a wireless signal from a base station and identifying a plurality of OFDM symbols of a primary synchronization signal of the wireless signal on a time domain;
transforming the OFDM symbols to a frequency domain to generate a plurality of original symbol signals;
generating an inner product of the original symbol signals and a plurality of received symbol signals to obtain a product of a power leakage coefficient and a channel gain; and
approximating an actual value of a fractional carrier frequency offset of the wireless signal according to the power leakage coefficient by using a line search method.

9. The wireless communication device of claim 8, wherein the power leakage coefficient is a function of the fractional carrier frequency offset, and the time and frequency synchronization method further comprises:
searching for the fractional carrier frequency offset that makes a square of the power leakage coefficient reach a maximum by using the line search method.

10. The wireless communication device of claim 8, wherein the time and frequency synchronization method further comprises:
selecting a first subset of the original symbol signals, wherein the original symbol signals of the first subset and the original symbol signals in a second subset neighboring to the first subset are orthogonal to each other; and
generating the inner product of the original symbol signals of the first subset and the corresponding received symbol signals to obtain the product of the power leakage coefficient and the channel gain.

11. The wireless communication device of claim 8, wherein the line search method comprises a golden section search method, a Fibonacci search method, a dichotomous search method or a sequential search method.

12. The wireless communication device of claim 8, wherein the time and frequency synchronization method further comprises:
detecting a sector ID according to an integer carrier frequency offset of the wireless signal.

13. The wireless communication device of claim 8, wherein the time and frequency synchronization method further comprises:
detecting a cell ID from a secondary synchronization signal (SSS) of the wireless signal according to the fractional carrier frequency offset.

14. The wireless communication device of claim 8, wherein the time and frequency synchronization method further comprises:
determining a fractional carrier frequency offset compensating value according to the fractional carrier frequency offset; and
performing compensation on the wireless signal according to the fractional carrier frequency offset compensating value.

15. A non-transitory computer readable medium that stores a computer program comprising a plurality of computer readable instructions to execute a time and frequency synchronization method used in a wireless communication device, the wireless communication device comprises a storage module configured to store the computer executable instructions and a processing module configured to execute the computer executable instructions to execute the time and frequency synchronization method, the time and frequency synchronization method comprises:
receiving a wireless signal from a base station and identifying a plurality of OFDM symbols of a primary synchronization signal of the wireless signal on a time domain;
transforming the OFDM symbols to a frequency domain to generate a plurality of original symbol signals;
generating an inner product of the original symbol signals and a plurality of received symbol signals to obtain a product of a power leakage coefficient and a channel gain; and
approximating an actual value of a fractional carrier frequency offset of the wireless signal according to the power leakage coefficient by using a line search method.
